(19) United States
(12) Patent Application Publication
(10) Pub. No.: US 2026/0340435 A1
(43) Pub. Date: Oct. 29, 2026

(54) TABULAR DATA AUGMENTATION THROUGH SEMANTIC TEXT ANALYSIS AND LABELING

(71) Applicant: Microsoft Technology Licensing, LLC, Redmond, WA (US)

(72) Inventors: Sumit GULWANI, Sammamish, WA (US); Mukul SINGH, Seattle, WA (US); Ashish TIWARI, Sammamish, WA (US); Ananya SINGHA, Ranchi (IN)

(21) Appl. No.: 19/191,085

(22) Filed: Apr. 28, 2025

(51) Int. Cl. G06N 5/022

(52) U.S. Cl. CPC G06N 5/022

(57) ABSTRACT

Technology disclosed herein includes systems and methods for semantic text column augmentation in tabular datasets. In an embodiment, an augmentation system generates embeddings that represent semantic characteristics of textual entries in a tabular dataset and applies a selection algorithm to the embeddings to identify a diverse subset of the entries. The augmentation system sends the diverse subset to a language model to obtain labels for the diverse subset, receives the labels from the language model, and then determines semantic similarity between the embeddings of the diverse subset and the embeddings of the remaining textual entries. The system further assigns labels to the remaining textual entries based on the labels for the diverse subset and the semantic similarity between the embeddings.

### TECHNICAL FIELD

Aspects of the disclosure relate to the field of computer hardware and software and, in particular, to labeling textual data based on semantic characteristics.

### BACKGROUND

Recent advances in artificial intelligence (AI) have led to the widespread adoption of large language models (LLMs) for processing and analyzing textual data. LLMs, such as those based on transformer architectures, are trained on large amounts of text and can generate human-like responses, classify content, and extract meaningful features from unstructured data. These models are highly versatile but computationally expensive, particularly when applied to large datasets. Additionally, these models often lack consistency in labeling tasks, as their outputs can vary depending on context, prompt phrasing, and model parameters.

Embeddings are a more efficient alternative to LLMs, which convert text into numerical vectors that capture semantic meaning. Embeddings allow for similarity-based retrieval, clustering, and classification by mapping similar text inputs to nearby points in a high-dimensional space. Various pre-trained embedding models enable fast and scalable text processing. However, while embeddings reduce computational overhead compared to full LLM inference, they still require robust strategies to maintain accuracy, especially when applied to diverse or noisy datasets.

Current approaches for categorizing and labeling text data typically fall into one of two categories: fully automated LLM-based methods and traditional machine learning models trained on manually labeled data. Fully automated LLM-based methods can be prohibitively expensive and inconsistent, while traditional supervised learning approaches require large, labeled datasets, which are costly and time-consuming to create. Furthermore, many existing tools lack adaptability, making it difficult to apply them effectively across different domains, datasets, and business applications. As textual data continues to grow in volume and complexity, there is a growing need for efficient, scalable, and cost-effective solutions for extracting structured insights from unstructured text.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

Technology disclosed herein pertains to the augmentation of text columns in tabular datasets. More specifically, the present technology uses a multi-step approach to efficiently extract semantic features from text columns and assign appropriate labels to unstructured text. In various embodiments, a computing apparatus implemented in program instructions executed by processing circuitry generates embeddings of textual entries in a tabular dataset, with the embeddings representing semantic characteristics of the textual entries. The computing apparatus then applies a selection algorithm to the embeddings to identify a diverse subset of the textual entries and sends this diverse subset to a language model to obtain labels. The apparatus receives the labels for the textual entries in the diverse subset as output from the language model, determines semantic similarity between the embeddings of the textual entries in the diverse subset and the embeddings of the textual entries in a remaining set, and assigns labels for the textual entries in the remaining set based on the determined semantic similarity.

Overall, this approach improves computational efficiency and cost-effectiveness of text column augmentation by reducing the number of language model calls required while also maintaining high accuracy in semantic classification. This approach enables automated assignment of meaningful labels to large text columns or lists at scale through a unique combination of smart sampling, language model-based labeling, and embedding-based propagation of the labels to the full dataset. This featurization process provides efficient and accurate semantic labeling that would otherwise be prohibitively expensive or time-consuming.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIGS. 1A-1B illustrate a computing environment in accordance with some embodiments of the present technology.

FIG. 2 is a flowchart illustrating a series of steps performed by an augmentation service in accordance with some embodiments of the present technology.

FIG. 3 is a sequence diagram illustrating a series of steps performed, in an implementation, with respect to the computing environment of FIGS. 1A-1B and the flowchart of FIG. 2.

FIGS. 4A-4B illustrate table augmentation in the context of a user experience in accordance with some embodiments of the present technology.

FIG. 5 illustrates another user experience in accordance with some embodiments of the present technology.

FIG. 6 illustrates a computing system suitable for implementing the various operational environments, architectures, processes, scenarios, and sequences discussed below with respect to the other Figures.

### DETAILED DESCRIPTION

Technology disclosed herein pertains to the augmentation of textual data based on semantic characteristics. More specifically, the present technology provides a systematic approach for labeling tabular data that includes extracting meaningful semantic features from text columns by employing a multi-step process that combines diverse subset selection, language model-based labeling, and embedding-based propagation. In various implementations, the disclosed methods include generating embeddings that represent semantic characteristics of textual entries in a tabular dataset, applying a selection algorithm to identify a diverse subset of the textual entries, sending the diverse subset to a large language model (LLM) to obtain labels, determining semantic similarity between the embeddings of the labeled textual entries and the remaining textual entries, and propagating the labels to the remaining set based on the semantic similarity.

Extracting meaningful insights from textual data presents significant technical challenges in data analysis workflows. Traditional methods for processing text columns in datasets often rely on syntactic features and overlook semantic dimensions, resulting in suboptimal categorization and feature extraction. Manual annotation of large text columns is resource-intensive and time-consuming, while existing automated approaches typically fail to capture the semantic characteristics present in natural language data. These limitations are particularly pronounced in tabular data processing applications such as spreadsheet environments, where users frequently need to analyze text-heavy columns that may contain product reviews, customer feedback, business descriptions, or other unstructured content.

The technology disclosed herein addresses these limitations through an automated system for semantic text column featurization, enabling efficient categorization and labeling of textual data through a scalable approach. To begin, the system generates embeddings of the textual entries that represent their semantic characteristics. The selection algorithm then identifies a diverse subset of the textual entries that captures the semantic variation present in the dataset. Instead of processing the entire dataset, this selective sampling approach identifies a representative subset that preserves the range of semantic characteristics while significantly reducing computational requirements. The system then applies a language model to this diverse subset to generate meaningful semantic labels. Finally, the system assigns these labels to the remaining textual entries by determining semantic similarity between the embeddings of the diverse subset and the embeddings of the remaining set.

In some implementations, the disclosed system operates within a computing environment optimized for data analysis workflows in spreadsheet applications. The architecture may include some of all of: a user application interface, a computational backend for embedding generation and processing, integration with one or more language models, and database components for storing associated data. The user application serves as the primary interface, allowing users to initiate augmentation operations, review generated labels, and incorporate the resulting categorizations into their analysis workflows. The computational backend manages the embedding-based selection and label assignment processes, while the language model component handles the semantic labeling of the diverse subset.

An operational workflow in accordance with the system disclosed herein begins with sending textual entries to a text embedding model to generate embeddings that represent semantic characteristics. The system then applies a selection algorithm to identify a diverse subset that captures the semantic variation present in the full dataset. This diverse subset is processed by a language model, which assigns semantic labels according to the identified categories. Finally, the system assigns labels to the remaining textual entries by determining semantic similarity between embeddings. This workflow encompasses three distinct processes: (1) diverse subset selection using embedding-based algorithms, (2) semantic labeling of the diverse subset using a language model, and (3) label assignment through semantic similarity determination. This process enables efficient semantic featurization that scales effectively to large datasets while maintaining accuracy and consistency.

In some implementations, the disclosed system leverages pre-trained embedding models to transform textual data into vector representations that capture semantic characteristics. The embedding process maps similar text into nearby points in the embedding space, enabling effective diverse subset identification and similarity-based label assignment. The system may employ multiple types of selection algorithms, including but not limited to clustering-based approaches that group similar embeddings, principal component analysis (PCA) techniques that identify points along principal components, and distance-based sampling methods.

Various technical effects may be appreciated from the implementations disclosed herein. The diverse subset selection approach significantly reduces computational requirements by focusing language model processing on a small, representative subset rather than the entire dataset. This targeted processing yields substantial computational efficiencies compared to applying language models to every textual entry in large datasets. By decomposing the semantic featurization process into discrete steps, the system reduces both cost and time requirements while maintaining high-quality results. The embedding-based label assignment provides consistent categorization across the dataset without requiring language model inference for each textual entry. This architecture enables data augmentation at scale, making it practical for deployment in production environments with large datasets.

The disclosed approach exhibits distinct technical advantages over alternative methods. Compared to direct application of language models to entire datasets, the system reduces computational costs by approximately two orders of magnitude while maintaining comparable accuracy. The embedding-based selection and assignment techniques provide reliable operation even with extremely large datasets where direct language model processing would be prohibitively expensive. Additionally, the approach disclosed herein delivers more consistent labeling compared to sequential language model processing, which can exhibit variation in label terminology across different processing batches. The system's architecture provides a clear technical improvement in both efficiency and consistency for semantic text column featurization.

In one use case, the augmentation system enables automatic categorization of customer reviews in a product database. When analyzing numerous product reviews (e.g., hundreds or thousands), the system generates embeddings of the textual entries, identifies a small, diverse subset using the selection algorithm, applies an LLM to obtain labels for the diverse subset, and assigns these labels to the remaining reviews based on semantic similarity. This enables efficient filtering, aggregation, and analysis of reviews by product category without requiring manual annotation or exhaustive language model processing. Through this approach, data analysts can extract insights from large collections of textual feedback, significantly enhancing analytical capabilities.

While many examples throughout this specification are given in the context of spreadsheet applications and tabular data analysis, the disclosed system applies across diverse domains that may involve textual data categorization or labeling. The methodology of diverse subset selection, language model labeling, and label propagation may be applied in domains including but not limited to customer relationship management, content management systems, e-commerce platforms, business intelligence systems, and many more. This approach addresses the technical challenge of extracting structured features from unstructured textual data across computational systems where manual annotation would be impractical and complete language model processing would be prohibitively expensive.

Although the implementation examples primarily reference large language models for the labeling step, the semantic featurization framework disclosed herein is applicable across various language model architectures. For example, this disclosed approach may be implemented with transformer-based neural networks, rule-based text classification systems, and other text processing frameworks. The system's design remains effective regardless of the underlying language model implementation, provided the model possesses sufficient semantic understanding capabilities to generate meaningful labels for textual entries.

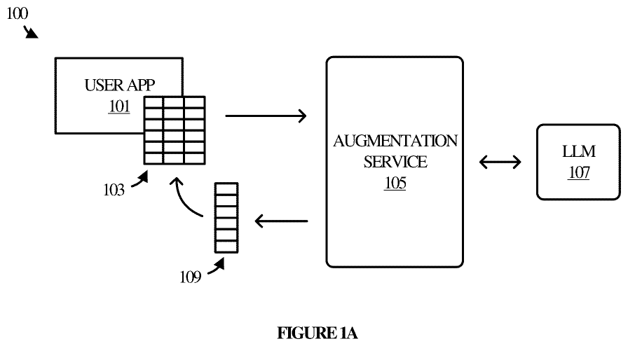

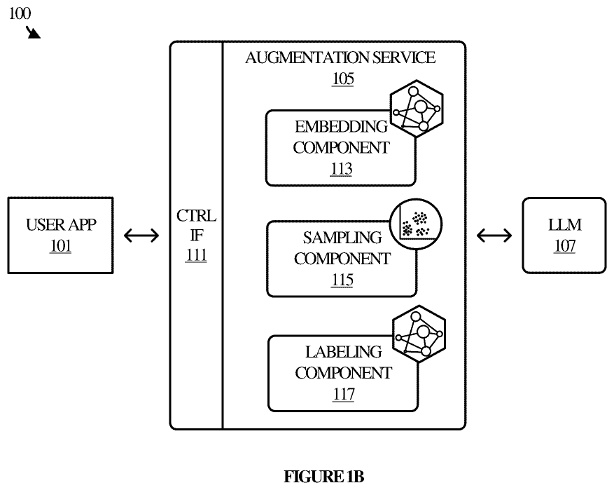

FIG. 1A illustrates system 100 in an implementation. System 100 provides a framework for semantic text column augmentation of tabular data, integrating various components to facilitate the extraction of meaningful semantic features from textual data. This augmentation process encompasses featurization techniques that identify, extract, and represent semantic characteristics of the text as structured labels or categories. System 100 includes user application 101, table 103, augmentation service 105, LLM 107, and labels 109. The elements of FIG. 1A may interact through various data flows to facilitate the labeling of textual entries in a tabular dataset. The elements depicted in FIG. 1A are presented solely for purposes of example, and system 100 may include additional, fewer, or alternative elements than those illustrated.

User application 101 represents a client-side software component through which end users interact with tabular data, typically viewing, editing, and analyzing structured information. User application 101 may include spreadsheet applications, database clients, word processing applications, business intelligence tools, data analysis platforms, or other software incorporating list-based and/or tabular data processing capabilities. User application 101 operates on one or more computing devices of various form factors and processing architectures. Specifically, user application 101 may execute on desktop computing systems, laptop computers, tablet devices, mobile smartphones, thin clients, or specialized workstations depending on deployment context. User application 101 may support both local installation models and web-based delivery mechanisms that operate within browser environments.

Table 103 represents structured data within user application 101, containing rows and at least one column of textual entries. Table 103 may be in the form of a structured table (i.e., formatted as a table) or an unstructured table, and may be implemented as a spreadsheet data range, a database table, a CSV file representation, or other tabular data structures that organize information into rows, columns, and/or lists. The textual entries in table 103 may include product reviews, customer feedback, survey responses, narrative descriptions, technical documentation, or other unstructured text for semantic analysis and categorization to facilitate downstream analysis. Table 103 provides the source data for the featurization process, with some or all of its contents being transmitted to augmentation service 105 for analysis.

Table 103 supports the integration of derived semantic labels as structured data columns. When the featurization process completes, augmentation service 105 may populate a new column in the spreadsheet with the generated labels, adjacent to the original textual data in some examples, preserving row associations and structural format. In some cases, the newly populated column inherits appropriate data type definitions, formatting rules, header information, and the like, based on the semantic categorization performed. This direct integration enables immediate utilization of the semantic labels for filtering, sorting, analysis, and visualization operations within the spreadsheet environment without requiring additional data extraction or manual transfer processes.

Augmentation service 105 represents a computational service that processes textual entries from table 103 to extract semantic features and generate appropriate labels. Augmentation service 105 may be provisioned as a cloud-based service, a local application component, or a hybrid architecture combining local processing with remote capabilities. Augmentation service 105 implements the core technical operations of the featurization process, including generating embeddings of textual entries, applying selection algorithms to identify diverse subsets, and determining semantic similarity between embeddings to propagate labels. Augmentation service 105 may incorporate various embedding techniques, selection algorithms such as clustering-based sampling, principal component analysis, or distance-based sampling, and similarity-based mapping techniques including cosine similarity mapping, nearest neighbor classification, or embedding distance-based label propagation.

LLM 107 represents a large language model deployed in a cloud-based environment or other computational infrastructure. LLM 107 processes the diverse subset of textual entries identified by augmentation service 105 to generate semantically appropriate labels. LLM 107 may be implemented using various types of machine learning models, including but not limited to transformer-based neural networks, recurrent neural networks (RNNs), or hybrid architectures combining multiple techniques. LLM 107 may be accessed through standardized API interfaces with appropriate rate limiting, authentication mechanisms, and request prioritization to provide reliable and cost-effective operation during the labeling process.

Labels 109 represents the output of the featurization process, containing the semantic categories or classifications assigned to each textual entry in table 103. Labels 109 provides structured information that captures the semantic characteristics of the original textual entries, enabling more effective analysis, filtering, and insight generation within user application 101. Labels 109 may be formatted as a column of categorical values, a set of tags, hierarchical classifications, or other structured representations of semantic features that can be integrated with the original tabular dataset for downstream analysis and visualization.

FIG. 1B illustrates another view of system 100 in an implementation, specifically showing additional architectural details of augmentation service 105. As shown in FIG. 1B, augmentation service 105 includes control interface 111, embedding component 113, sampling component 115, and labeling component 117. The elements depicted in FIG. 1B are presented solely for purposes of example, and system 100 may include additional, fewer, or alternative elements than those illustrated.

Control interface 111 functions as a coordination layer within augmentation service 105, managing workflow orchestration, component interaction, and operational sequencing. Control interface 111 directs the processing pipeline by coordinating data flow between embedding component 113, sampling component 115, and labeling component 117. Control interface 111 may implement request validation, parameter processing, authentication verification, error handling protocols, and logging mechanisms to maintain operational integrity throughout the featurization process, as just a few examples. Control interface 111 may be implemented as a REST API endpoint, gRPC service, message queue consumer, event-driven microservice, or the like, depending on deployment architecture. Control interface 111 may accommodate both synchronous processing for interactive workflows and asynchronous processing for batch operations, as well as appropriate request throttling and queue management to optimize resource utilization during periods of high demand.

Embedding component 113 generates vector representations of textual entries that capture semantic characteristics in a high-dimensional space. Embedding component 113 processes raw text strings from the tabular dataset and transforms them into numerical vectors using various embedding techniques. Embedding component 113 may be implemented using pre-trained embedding models such as transformer-based encoders, word embedding models, sentence encoders, or domain-specific embedding models fine-tuned for particular industry verticals. The component may utilize multiple embedding models in parallel to capture different semantic dimensions, with subsequent fusion techniques that effectively combine these representations. Embedding component 113 may be deployed as containerized instances within cloud environments, dedicated hardware accelerators with specialized tensor processing units, edge devices with optimized inference capabilities for low-latency embedding generation, or other deployments in other examples. In some examples, embedding component 113 implements caching mechanisms to avoid redundant embedding computations for frequently occurring text patterns, reducing computational overhead and improving responsiveness for interactive applications.

Sampling component 115 applies one or more selection algorithms to the embeddings produced by embedding component 113 to identify a diverse subset of textual entries that represent the semantic variation present in the full dataset. Sampling component 115 processes the embeddings generated by embedding component 113 to select representative samples that capture the range of semantic characteristics within the dataset. Sampling component 115 may implement various sampling techniques including but not limited to clustering-based sampling algorithms that group similar embeddings and select representatives from each cluster; principal component analysis algorithms that identify extreme points along principal components to maximize diversity; distance-based sampling algorithms that select points based on their distribution in the embedding space; and stratified random sampling algorithms that ensure representation across different semantic regions. In some instances, sampling component 115 may dynamically adjust sampling parameters based on dataset characteristics, such as size, sparsity, and dimensional distribution, to optimize diversity coverage while minimizing the sample size. Sampling component 115 may be implemented using distributed computing frameworks for large-scale datasets, specialized clustering libraries optimized for high-dimensional vector spaces, or custom algorithms designed to handle the specific characteristics of text embeddings, in some implementations.

Sampling component 115 selects the diverse subset to represent the full range of semantic characteristics present in the dataset. This selection may be based on several different types of criteria, including but not limited to distributional coverage across the embedding space, statistical variation of semantic features, and embedding space density patterns. These criteria are employed to identify textual entries that capture the full semantic landscape of the data while minimizing redundancy in the selected subset.

Labeling component 117 performs dual functions in the featurization process: obtaining initial labels for the diverse subset through LLM 107 and extending these labels to the remaining textual entries. For the initial labeling phase, labeling component 117 constructs one or more appropriate prompts for LLM 107, manages context limitations, processes responses, and handles error cases or ambiguous outputs. In some examples, labeling component 117 may implement techniques such as prompt engineering, few-shot learning approaches, and structured output formatting to optimize label quality and consistency from LLM 107. For the label extension phase, labeling component 117 employs similarity-based mapping techniques to propagate labels from the diverse subset to the remaining textual entries not in the diverse subset. These techniques may include but are not limited to cosine similarity mapping that assigns labels based on vector similarity; nearest neighbor classification that identifies the closest labeled entries; embedding distance-based label propagation that considers distances in embedding space; clustering-based label assignment that groups similar entries; classification algorithm-based propagation that trains lightweight models on the labeled subset; and neural network-based label assignment that learns transfer functions between labeled and unlabeled data. Labeling component 117 may be implemented as a scalable service with dynamic resource allocation, prioritizing either precision or recall based on application requirements. The component incorporates confidence scoring mechanisms to identify cases where human review may be beneficial, enabling semi-supervised workflows in high-stakes applications.

Labeling component 117 may also include interactive functionality that allows users to review and/or modify the labels assigned to the diverse subset prior to propagation. This user validation step enables a user to correct or change any labels that have been assigned by LLM 107 before they are propagated to the remaining dataset. The system then preserves these user modifications during the subsequent labels propagation phase, maintaining the integrity of user-defined semantic categorizations throughout the remaining dataset.

In addition to or instead of the described interactive functionality, the augmentation system may support multiple distinct interaction modes that facilitate varying levels of user involvement in the semantic labeling process, in some examples. In an unsupervised mode, the system autonomously analyzes text columns, selects diverse samples, generates labels, and applies them without explicit user intervention, making this a suitable option for background processing and large-scale automation. In a user-guided mode, the user may specify parameters such as column names or desired label categories, enabling directed semantic analysis while still leveraging the system's automated capabilities. In a “by-example” mode, the augmentation system may operate semi-autonomously, detecting when a user begins manual labeling of the first few rows and automatically extrapolating this pattern to the remaining dataset using the three-step process. In a review-and-modify mode, the system may present its initially generated labels for the diverse subset to a user for validation or correction before propagating these validated labels to the complete dataset, enabling quality control while maintaining computational efficiency.

The components of augmentation service 105 may be deployed across various architectural patterns depending on scale, latency, and privacy requirements. In cloud-native deployments, the components may operate as containerized microservices, with horizontal scaling capabilities to accommodate varying workloads. In edge computing scenarios, the components may be optimized for resource-constrained environments, utilizing quantized models and efficient algorithms to enable on-device processing of sensitive data. In hybrid deployments, embedding and sampling functions may occur on local infrastructure while labeling leverages cloud-based language models. Regardless of deployment architecture, augmentation service 105 maintains consistent interfaces and processing pipelines while adapting to infrastructure constraints and performance objectives.

In an exemplary implementation, augmentation service 105 utilizes a configuration in which embedding component 113 employs pretrained transformer-based text embeddings, sampling component 115 implements principal component analysis (PCA) for diverse subset selection, and labeling component 117 utilizes direct label similarity-based propagation. This specific configuration offers several technical advantages. For example, PCA-based sampling efficiently identifies datapoints that represent extreme values along principal components, effectively capturing semantic diversity with minimal sampling overhead. Direct label similarity propagation provides computationally efficient label extension without requiring intermediate processing steps or expansion operations. Performance analyses indicate this configuration achieves a good balance between accuracy and computational efficiency across diverse datasets, with significantly reduced processing time compared to baseline approaches. The architectural flexibility of augmentation service 105, however, allows for alternative component implementations based on specific deployment constraints, dataset characteristics, or domain-specific requirements, enabling adaptation to various operational scenarios while maintaining the core featurization workflow.

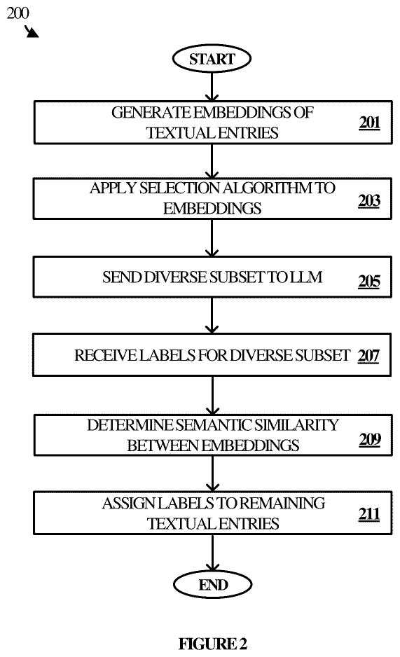

FIG. 2 illustrates process 200. Process 200 is an exemplary operation of semantic text column featurization in the context of system 100. The operations may vary in other examples. The operations of process 200, in some examples, are performed within one or more components of augmentation service 105 in the example of FIGS. 1A-1B. Process 200 may be implemented in program instructions in the context of the software and/or firmware elements of augmentation service 105. The program instructions, when executed by one or more processing devices of one or more suitable computing devices, direct the one or more computing devices to operate as follows, referring to the steps of FIG. 2 in reference to a singular to a computing device for the sake of clarity.

In operation, the computing device generates embeddings of textual entries in a tabular dataset (step 201). The embeddings represent semantic characteristics of the textual entries in a multi-dimensional vector space where semantically similar texts are positioned closer together. In the example of FIG. 1B, embedding component 113 processes the textual entries to generate the embeddings. The embedding generation process may utilize various embedding techniques including transformer-based text encoders, word embedding models, sentence encoders, and/or domain-specific embedding models trained for particular verticals or industries.

In some examples, the computing device may implement dimensionality reduction techniques such as t-SNE (t-distributed Stochastic Neighbor Embedding) or UMAP (Uniform Manifold Approximation and Projection) to facilitate visualization and processing of high-dimensional embeddings. For tabular datasets with multilingual content, the embedding process may employ cross-lingual embedding models to maintain semantic consistency across languages. In enterprise deployments, embedding generation may be accelerated using dedicated hardware such as GPUs or TPUs to minimize processing latency, particularly for large datasets.

The computing device applies a selection algorithm to the embeddings to identify a diverse subset of the textual entries (step 203). The diverse subset comprises textual entries that represent the range of semantic characteristics within the tabular dataset. In the example of FIG. 1B, sampling component 115 applies the selection algorithm to the embeddings generated by embedding component 113. The selection algorithm may include various techniques such as clustering-based sampling, principal component analysis, distance-based sampling, stratified random sampling, or the like.

Clustering-based sampling algorithms group similar embeddings and select representatives from each cluster, effectively partitioning the embedding space to ensure coverage across semantic regions. Principal component analysis identifies the primary axes of variation in the embedding space and selects points that represent extreme values along these principal components, maximizing diversity with minimal sampling. Distance-based sampling algorithms select points based on their distribution in the embedding space, prioritizing examples that maximize coverage of the semantic landscape. The selection process may dynamically adjust parameters based on dataset characteristics such as size, sparsity, and dimensional distribution.

The computing device sends the diverse subset to a language model to obtain labels for the textual entries in the diverse subset (step 205). The diverse subset represents a significantly reduced number of examples compared to the full dataset, making language model processing more cost-effective and efficient. In the example of FIG. 1B, labeling component 117 sends the diverse subset identified by sampling component 115 to LLM 107 for labeling. LLM 107 processes each textual entry in the diverse subset and generates appropriate semantic labels based on its understanding of the content.

The prompt construction for the language model may vary depending on implementation requirements. Zero-shot prompting approaches may rely solely on general instructions to the language model without examples, while few-shot prompting may include a small number of labeled examples to guide the language model's response format and labeling approach. The language model may be directed to generate labels according to specific taxonomies or categorical systems depending on the application domain. In specialized domains such as legal, medical, or technical contexts, the prompts may incorporate domain-specific terminology or classification schemes to enhance labeling accuracy.

The computing device receives the labels for the textual entries in the diverse subset as output from the language model (step 207). These labels represent the semantic categories assigned to each textual entry in the diverse subset based on the language model's analysis. In the example of FIG. 1B, labeling component 117 receives the labels from LLM 107. The labels provide structured information that captures the semantic characteristics of the textual entries in the diverse subset.

The labels may take various forms depending on the specific use case and language model configuration. Single-category classification assigns one label per textual entry, while multi-label classification allows for multiple applicable categories per entry. Hierarchical labeling schemes may be used for domains requiring multiple levels of categorization, establishing parent-child relationships between labels. In some examples, the system may implement confidence scoring mechanisms where the language model provides certainty estimates alongside each label, enabling downstream filtering or human review of low-confidence assignments.

The computing device determines semantic similarity between the embeddings of the textual entries in the diverse subset and the embeddings of the textual entries in a remaining set of the textual entries (step 209). This computational process establishes quantifiable relationships between labeled and unlabeled entries, creating the foundation for subsequent label propagation. In the example of FIG. 1B, labeling component 117 calculates these similarity measurements as a prerequisite for extending labels to the full dataset. These similarity computations directly enable the identification of appropriate labels for each unlabeled entry through their semantic proximity to already-labeled examples.

Semantic similarity may be computed using various distance metrics in the embedding space, including but not limited to cosine similarity, Euclidean distance, Manhattan distance, or Mahalanobis distance depending on the specific characteristics of the embedding distribution. For high-dimensional embeddings, the system may apply dimensionality-aware similarity measures that account for the curse of dimensionality. The similarity determination process may incorporate approximate nearest neighbors algorithms such as locality-sensitive hashing, hierarchical navigable small worlds, or randomized partition trees when processing large-scale datasets to maintain computational efficiency. These similarity computations inform the assignment of labels by establishing quantifiable semantic relationships between the diverse subset and remaining entries.

The computing device then assigns labels for the textual entries in the remaining set based on the labels for the textual entries in the diverse subset and the semantic similarity (step 211). This step leverages the computed similarity metrics to systematically propagate labels from the diverse subset to all remaining textual entries. In the example of FIG. 1B, labeling component 117 applies one or more similarity-based mapping techniques that utilize the similarity relationships established in step 209. These techniques may include but are not limited to cosine similarity mapping that directly assigns labels based on highest similarity scores, nearest neighbor classification that identifies the k-closest labeled entries, embedding distance-based label propagation that weighs multiple potential labels by their proximity, clustering-based label assignment that groups similar entries post-similarity computation, classification algorithm-based propagation that trains lightweight models on similarity features, or neural network-based label assignment that learns complex similarity-to-label mappings.

The label assignment process may implement various strategies to handle edge cases and ambiguities identified during similarity determination. Majority voting approaches apply when the similarity computation in step 209 identifies multiple labeled entries with comparable semantic proximity to an unlabeled entry, selecting the most common label among the nearest neighbors. Weighted voting schemes assign influence proportional to the similarity scores computed in the previous step. For datasets with hierarchical label structures, the propagation may follow hierarchical constraints informed by the similarity relationships. The system incorporates confidence scores derived from the similarity metrics in the final output, providing transparency about labeling certainty and enabling downstream applications to filter or prioritize entries based on the strength of the similarity relationships established in step 209.

In implementations where user modification of labels is supported, the computing device incorporates these modifications prior to the propagation step. This allows users to review and adjust the initial set of labels assigned to the diverse subset, correcting any potential misclassifications or change labels before they affect the entire dataset. The modified labels then serve as the foundation for the similarity-based propagation, maintaining consistency with the user's preferences throughout the labeled dataset.

Following step 211, in some implementations, the computed labels are integrated into the tabular structure through a column population process. The computing device may generate a new column in the spreadsheet (e.g., adjacent to the original text column) with the assigned labels, maintaining row alignment between the textual entries and their corresponding labels. The system may format the column according to appropriate data type definitions, apply consistent styling for visual clarity, and/or generate appropriate header information that reflects the semantic categorization performed. The direct integration of the labels in the spreadsheet may allow for immediate utilization of the labels within existing analysis workflows, allowing for filtering, sorting, and visualization operations without requiring additional data manipulation steps.

Process 200, which includes generating embeddings, applying a selection algorithm, sending the diverse subset to a language model, receiving labels, determining semantic similarity, and assigning labels, can be executed in various operational modes. In a batch processing mode, for example, all steps may be performed sequentially on a complete dataset. In a streaming mode, embeddings and labels may be computed incrementally as new data arrives, with periodic retraining of the selection model to maintain representation quality. In hybrid modes, the system may maintain persistent embeddings and selection models while performing labeling and propagation on demand.

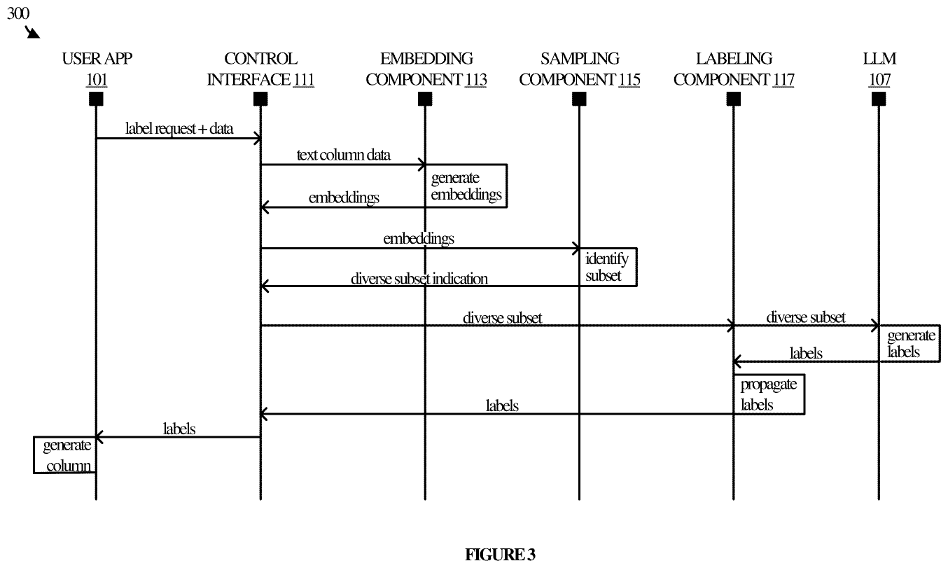

FIG. 3 illustrates operational scenario 300. Operational scenario 300 depicts an example of an interaction flow between various components for semantic text column augmentation. Operational scenario 300 involves the interaction between user application 101, control interface 111, embedding component 113, sampling component 115, labeling component 117, and LLM 107.

The operational scenario begins within the context of an AI-augmented productivity application, such as a spreadsheet application with AI-assisted functionality. In this environment, the augmentation process may be initiated through multiple types of trigger mechanisms. For example, a user may explicitly request semantic categorization by submitting a direct prompt such as “label this column based on business categories” or “identify the sentiment in these customer reviews.” Alternatively, the AI assistant may proactively suggest column augmentation through intelligent content analysis when detecting a text-heavy column that would benefit from semantic structuring. This suggestion may appear as an actionable card in the assistant's interface stating “I can categorize this text data to help with your analysis” or similar contextual recommendations.

In some implementations, upon user initiation of the augmentation capability, either through explicit request, acceptance of a suggestion, or the like, the system initiates communication with the augmentation service through an intermediary middleware layer. This middleware functions as a communication broker between the client-side application components and cloud-based language model services. The middleware layer processes the initial request, formats the communication protocol, handles authentication and request prioritization, and establishes the processing pipeline. The middleware transfers the preprocessed request to augmentation service 105 via control interface 111, accompanied by the requisite data context including the text column data and any user-specified parameters such as desired categorization schemes or column headers. This middleware architecture enables integration between locally executing applications and remote AI processing capabilities while maintaining application responsiveness and appropriate resource utilization.

To begin the sequence, user application 101 submits the text column data to control interface 111 along with any contextual information from the augmentation loop. This submission includes the text column requiring semantic analysis, potentially accompanied by metadata that provides context about the column's nature, the user's domain, or specific augmentation requirements. In the context of a spreadsheet application, this may include information about adjacent columns, column headers, or worksheet context that could inform the semantic analysis. The augmentation loop maintains session state information throughout this process, ensuring that the augmentation results can be appropriately integrated back into the user's workflow upon completion.

Control interface 111 receives and processes this incoming request, which may include parsing the text column data, validating input parameters, and establishing the processing pipeline configuration. The interface may perform initial data assessment to determine optimal processing strategies based on factors such as column size, language detection, and text complexity. Control interface 111 routes the validated text column data to embedding component 113 (e.g., with a “generateEmbeddings” instruction). This routing operation may include configuration parameters specifying the embedding dimensionality, model selection, and/or batch processing requirements.

Embedding component 113 receives the text column data and generates embeddings for each textual entry. The component may apply text preprocessing operations such as normalization, tokenization, and special character handling before computing the embeddings, in some examples. For multilingual datasets, language-specific preprocessing rules may be applied to ensure consistent embedding quality across different languages. After processing the dataset, embedding component 113 returns the resulting vector representations to control interface 111. These embeddings may consist of high-dimensional numerical vectors (e.g., 768, 1024, or 1536 dimensions) that position semantically similar text entries closer together in the vector space.

Control interface 111 receives these embeddings and forwards them to sampling component 115 (e.g., with an “identifySubset” instruction). This instruction may includes parameters that govern the sampling strategy, such as desired sample size, diversity thresholds, or specific constraints on the representation distribution. Control interface 111, in some examples, maintains a mapping between the original text entries and their corresponding embeddings throughout this process, enabling downstream components to reference the original text when needed. The interface may also implement caching mechanisms to store intermediate results for potential reuse in subsequent operations.

Sampling component 115 then processes the embeddings to identify a diverse subset that maximally represents the semantic variation present in the dataset. For example, in a principal component analysis-based sampling, sampling component 115 first computes the principal components of the embedding space and then selects examples with extreme values along these components to capture the major axes of variation. After applying the selected sampling algorithm, sampling component 115 returns a diverse subset indication to control interface 111. This indication may include indices or identifiers referencing the selected entries within the original dataset and/or diversity metrics that quantify the representational coverage achieved by the sampling process.

The augmentation service then uses this diverse subset indication to extract the corresponding textual entries from the original dataset. The control interface, for example, may perform a mapping operation that translates the subset indices into the actual text content, maintaining all relevant metadata and contextual information. Control interface 111 then sends this extracted diverse subset to labeling component 117 (e.g., with a “generateLabels” instruction). This instruction may include additional parameters derived from the user's request or application context, such as label categories for by-label scenarios, examples for by-example cases, or column names for by-columnName implementations.

Labeling component 117 then processes the diverse subset and constructs an appropriate prompt for LLM 107. This prompt engineering process may involve formatting the textual entries, incorporating any user-specified constraints or examples, and/or structuring the request to optimize the language model's labeling performance. Labeling component 117 forwards the constructed prompt to LLM 107 with a label request accompanied by the subset data. This interaction establishes the critical bridge between the statistical embedding-based approaches and the semantic understanding capabilities of the language model.

In response to receiving the constructed prompt and/or diverse subset, LLM 107 processes the diverse subset and applies its contextual understanding to generate appropriate semantic labels. For by-columnName scenarios, LLM 107 may infer appropriate categories based on the specified column header. For unsupervised scenarios, LLM 107 may identify natural semantic groupings within the data. After completing the labeling process, LLM 107 returns the generated labels to labeling component 117. These labels represent the semantic categories that will serve as the foundation for the complete dataset labeling, providing human-interpretable structure to the textual information.

Labeling component 117 receives these labels back from LLM 107 and executes an operation to extend the labeling to some or all of the remaining textual entries (e.g., a “propagateLabels” operation). Using the embeddings generated earlier, labeling component 117 computes semantic similarity metrics between each unlabeled entry and the labeled entries in the diverse subset. Based on these similarity relationships, labeling component 117 assigns labels to all entries in the dataset. For implementations using direct label similarity propagation, this step involves comparing the embedding of each unlabeled entry with the embeddings of the labeled entries and assigning the label associated with the highest similarity score.

After completing the propagation of the labels, labeling component 117 returns the comprehensive set of labels to control interface 111. This labeled dataset includes semantic categories for some or all of the textual entries in the original text column, effectively transforming unstructured text into structured information. In some implementations, the labels may be accompanied by confidence scores or alternative category suggestions for entries with ambiguous classification, providing additional context for downstream applications.

Control interface 111, or one or more other components, processes the labels and formats the results for integration with user application 101. This formatting operation transforms the labels into a structure compatible with the user application's data model, applies appropriate data typing, and organizes the information according to application-specific requirements. For spreadsheet applications, this typically involves creating a new column structure that can be inserted adjacent to the original text data. Control interface 111 may also generate supplementary visualization data or summary statistics to enhance the presentation of the labeled information within the application context.

The operational scenario concludes with control interface 111 returning the labeled column to user application 101. Within the augmentation loop, the AI-enhanced productivity application integrates the labeled column into the user's workspace. For spreadsheet applications, this may involve creating a new column in the worksheet with appropriate formatting and headers. The augmentation loop may also provide explanatory content to help the user understand how the semantic categorization was performed and how to effectively utilize the newly structured data for analysis, filtering, or visualization purposes.

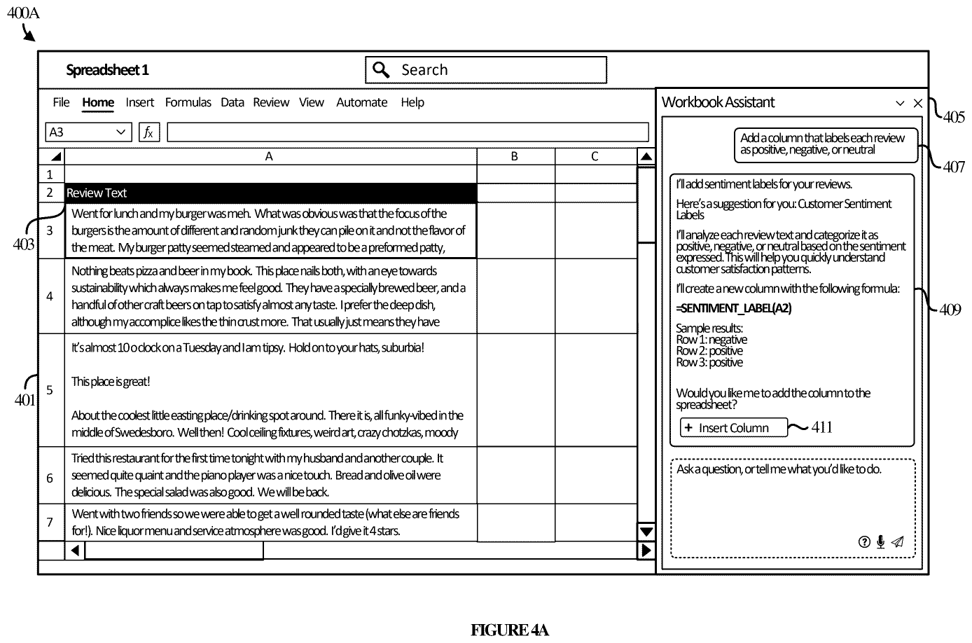

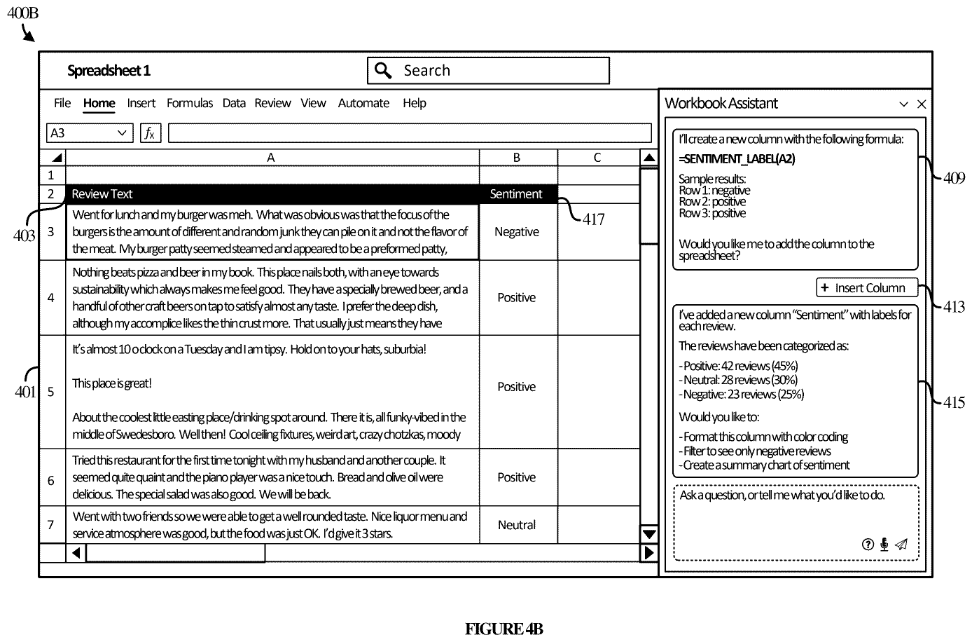

FIG. 4A illustrates user interface 400A in an implementation. User interface 400A is an exemplary representation of a spreadsheet application environment demonstrating components relevant to the process of text column augmentation. The spreadsheet application of FIG. 4A is representative of a user application that facilitates semantic analysis and labeling of tabular data. User interface 400A includes spreadsheet 401, review text column 403, workbook assistant 405, prompt 407, response 409, and insert column option 411.

Spreadsheet 401 represents a worksheet in the spreadsheet application, displaying a grid-based interface where users enter and manipulate tabular data. Spreadsheet 401 contains structured data arranged in rows and columns, with specific cells containing textual data in the form of restaurant reviews. In this example, spreadsheet 401 displays multiple rows of reviews in column A, with each row containing a different customer review of a dining establishment.

Review text column 403 represents a column of unstructured textual data within spreadsheet 401, containing multiple restaurant reviews of varying length and sentiment. The textual entries in review text column 403 contain natural language feedback about different dining experiences, providing the source data for semantic categorization and labeling. These reviews include diverse content describing various aspects of restaurant experiences such as food quality, atmosphere, service, and overall satisfaction.

Workbook assistant 405 represents an AI-powered interface component that facilitates natural language interaction between the user and the spreadsheet application. Workbook assistant 405 contains prompt 407, which records the user's natural language request (“Add a column that labels each review as positive, negative, or neutral”), and response 409, which contains the AI-generated explanation of the proposed semantic labeling operation.

Response 409 represents a generated content item produced by a language model in response to prompt 407. Response 409 includes multiple components: a descriptive title (“Customer Sentiment Labels”), an explanation of the proposed operation, a description of the computational approach (“I'll analyze each review text and categorize it as positive, negative, or neutral based on the sentiment expressed”), and a preview of expected results. The response also notes that this labeling will help the user understand customer satisfaction patterns across the dataset.

Insert column option 411 represents an interactive button element labeled “+Insert Column” that allows the user to execute the proposed column insertion operation. This control enables users to implement the suggested semantic labeling with a single click, initiating the three-step augmentation process of smart sampling, language model labeling, and mapping extension.

FIG. 4B illustrates user interface 400B in an implementation. User interface 400B represents the spreadsheet application after execution of data augmentation process, showing the completed labeling operation. User interface 400B includes spreadsheet 401, review text column 403, sentiment column 417, and response 415.

Spreadsheet 401 and review text column 403 remain consistent with FIG. 4A, maintaining the same arrangement of restaurant review data in column A. The primary transformation visible in FIG. 4B is the addition of sentiment column 417, which contains semantic labels for each review.

Sentiment column 417 represents the output of the augmentation process, containing categorical labels that classify each review as “Positive,” “Negative,” or “Neutral” based on sentiment analysis. These labels provide structured semantic information derived from the unstructured text in review text column 403. The labels are systematically applied to each review, creating a new dimension for data analysis and filtering.

Response 415 represents a textual response from the workbook assistant following the completion of the labeling process. Response 415 includes a statistical summary of the sentiment distribution across the dataset, providing quantitative insight into the proportions of positive (45%), neutral (30%), and negative (25%) reviews. Response 415 also presents a set of follow-up operations proposed by the workbook assistant, offering additional ways to leverage the newly created sentiment column. These suggestions include formatting options (color coding), filtering capabilities (viewing only negative reviews), and visualization possibilities (creating a summary chart).

While FIG. 4A and FIG. 4B illustrate an embodiment related to a spreadsheet application and restaurant reviews, this example is for demonstrative purposes only, and should not be construed as limiting the scope of the technology disclosed herein. The semantic text column featurization methodology applies across diverse data environments including but not limited to customer feedback databases, product description catalogs, medical records systems, legal document repositories, financial report collections, educational content management systems, technical documentation archives, and any other structured or semi-structured data repository containing textual information that can be semantically categorized.

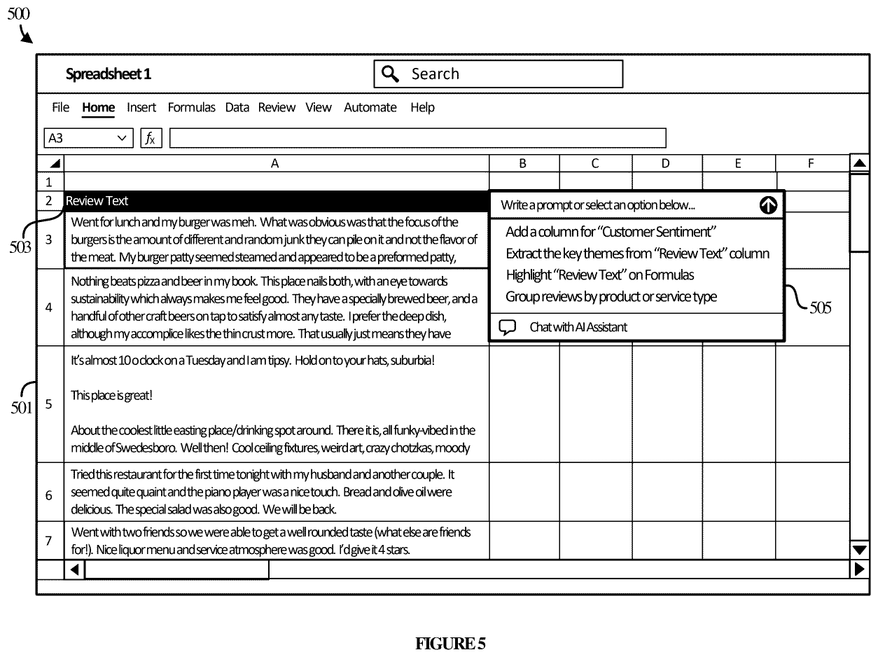

FIG. 5 illustrates user interface 500 in an implementation. User interface 500 depicts an alternative entry point for initiating the augmentation process within the spreadsheet application. The technology illustrated is applicable across various data environments containing text columns requiring semantic analysis and is not limited to the spreadsheet context shown. User interface 500 includes spreadsheet 501, review text column 503, and suggestion card 505.

Spreadsheet 501 represents a workspace of the spreadsheet application, displaying a grid-based interface where users manipulate tabular data. Spreadsheet 501 contains structured data arranged in rows and columns, with specific cells containing textual data in the form of reviews. Similar to the previous figures, spreadsheet 501 displays multiple rows of reviews in column A, with each row containing different customer feedback text.

Review text column 503 represents a column of unstructured textual data within spreadsheet 501. The textual entries in review text column 503 provide the source data for semantic categorization and labeling. Upon detecting this text column, the system may automatically analyze its content to identify potential semantic categorization opportunities.

Suggestion card 505 represents a contextual recommendation interface generated by the AI assistant integrated within the spreadsheet application. The suggestion card presents multiple semantic featurization options based on automated analysis of review text column 503. These options include “Add a column for ‘Customer Sentiment,’” “Extract the key themes from ‘Review Text’ column,” “Highlight ‘Review Text’ on Formulas,” and “Group reviews by product or service type.”

The AI assistant may generate these suggestions through several automated processes. In one example, an embedding component (e.g., embedding component 113) computes semantic representations of the textual data in review text column 503. These embeddings are then analyzed to identify potential categorical dimensions within the text. The system may identify sentiment patterns, topic clusters, keyword frequencies, and other semantic structures present in the text data. Based on this analysis, the AI assistant determines relevant semantic categorization options that would provide analytical value to the user.

Upon user selection of an option from suggestion card 505, such as “Add a column for ‘Customer Sentiment,’” the system initiates the multi-step column augmentation process described herein. Given that the embeddings may already be computed, the process may begin with the smart sampling step, where the system selects a diverse subset of text entries from review text column 503 using techniques such as principal component analysis on text embeddings. The selected samples are then sent to a language model for labeling, which generates semantic categories for the subset. Finally, the mapping extension step applies these labels to the entire dataset based on semantic similarity between embeddings.

Once again, the implementation depicted in FIG. 5 represents just one instantiation of the semantic text column featurization technology within a specific application context. The fundamental capabilities illustrated—automated text analysis, semantic pattern recognition, intelligent suggestion generation, and structured labeling processes—extend beyond spreadsheet applications to a diverse range of computational environments. For example, this approach applies equally to word processing applications, business intelligence platforms, data science notebooks, database management systems, content management solutions, enterprise resource planning software, customer relationship management tools, and any software environment where unstructured text requires systematic semantic categorization.

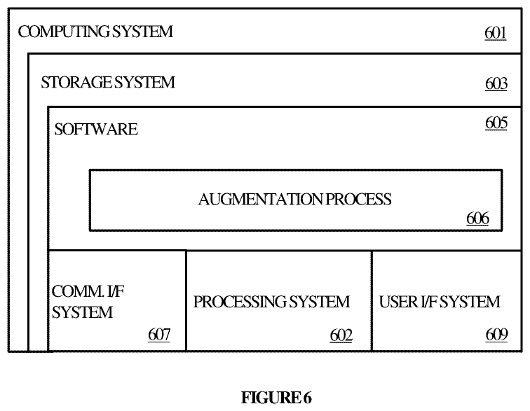

FIG. 6 illustrates computing device 601 that is representative of any computing apparatus or collection of devices on which the various processes, programs, services, and scenarios disclosed herein may be implemented. Examples of computing device 601 include, but are not limited to, server computers, desktop and laptop computers, tablet computers, mobile phones, audio devices, wearable devices (e.g., headphones, ear buds, eyeglasses, and wrist watches), industrial computers, microcontroller units (MCUs), Internet of Things (IoT) devices, and the like.

Computing device 601 may be implemented as a single apparatus, system, or device or may be implemented in a distributed manner as multiple apparatuses, systems, or devices. Computing device 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603. Software 605 includes and implements augmentation process 606, which is representative of the various data processing methods described above including but not limited to process 200. When executed by processing system 602, software 605 directs processing system 602 to operate as described herein for at least the various processes, operational scenarios, and sequences discussed in the foregoing implementations. Computing device 601 may optionally include additional devices, features, or functionality not discussed for purposes of brevity.

Referring still to FIG. 6, processing system 602 may include a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units (CPUs), graphical processing units (GPUs), neural processing units (NPUs), digital signal processors (DSPs), application specific integrated circuits (ASICs), and logic devices, as well as any other type of processing device, circuitry, or combinations and variations thereof.

Storage system 603 may include any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may include additional elements, such as a controller, capable of communicating with processing system 602 or possibly other systems.

Software 605 (including augmentation process 606) may be implemented in program instructions and among other functions may, when executed by processing system 602, direct processing system 602 to operate as described with respect to the various operational scenarios, sequences, and processes illustrated herein. For example, software 605 may include program instructions for implementing semantic text featurization as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software (including virtual machine software and container software), or other such application software. Software 605 may also include firmware or some other form of machine-readable processing instructions executable by processing system 602.

In general, software 605 may, when loaded into processing system 602 and executed, transform a suitable apparatus, system, or device (of which computing device 601 is representative) overall from a general-purpose computing system into a special-purpose computing system customized to perform table augmentation and/or semantic text featurization. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the disclosed technology may be embodied as a system, method, or computer program product. Accordingly, aspects of the technology may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the technology disclosed herein may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
generate embeddings of textual entries in a tabular dataset, wherein the embeddings of the textual entries represent semantic characteristics of the textual entries;
apply a selection algorithm to the embeddings to identify a diverse subset of the textual entries;
send the diverse subset to a language model to obtain labels for the textual entries in the diverse subset;
receive the labels for the textual entries in the diverse subset as output from the language model; and
determine semantic similarity between the embeddings of the textual entries in the diverse subset and the embeddings of the textual entries in a remaining set of the textual entries; and
assign labels for the textual entries in the remaining set based on the labels for the textual entries in the diverse subset and the semantic similarity between the embeddings of the textual entries in the diverse subset and the embeddings of the textual entries in the remaining set.

2. The computing apparatus of claim 1, wherein the tabular dataset comprises data in a table of a spreadsheet and the program instructions further direct the computing apparatus to populate a column in the spreadsheet with the labels for the textual entries in the diverse subset and the labels for the textual entries in the remaining set.

3. The computing apparatus of claim 1, wherein to determine the semantic similarity between the embeddings of the textual entries in the diverse subset and the embeddings of the textual entries in a remaining set, the program instructions direct the computing apparatus to apply at least one similarity-based mapping technique to the embeddings of the textual entries in the remaining set, wherein the similarity-based mapping technique propagates the labels for the textual entries in the diverse subset to the textual entries in the remaining set.

4. The computing apparatus of claim 3, wherein the similarity-based mapping technique comprises at least one of a cosine similarity mapping, a nearest neighbor classification, an embedding distance-based label propagation, a clustering-based label assignment, a classification algorithm-based propagation, and a neural network-based label assignment.

5. The computing apparatus of claim 1, wherein the selection algorithm comprises at least one of a clustering-based sampling algorithm, a principal component analysis algorithm, a distance-based sampling algorithm, and a stratified random sampling algorithm.

6. The computing apparatus of claim 1, wherein the language model comprises at least one of a large language model, a transformer-based neural network, and a rule-based text classification system.

7. The computing apparatus of claim 1, wherein the diverse subset comprises a subset of the textual entries that represent a range of semantic characteristics within the tabular dataset, and wherein the diverse subset is identified based on at least one of distributional coverage, statistical variation, and embedding space density.

8. The computing apparatus of claim 1, wherein the program instructions further direct the computing apparatus to, prior to assigning the labels for the textual entries in the remaining set, modify the labels for the textual entries in the diverse subset based on user input.

9. One or more computer readable storage media having program instructions stored thereon that, when executed by one or more processors of a computing apparatus, direct the computing apparatus to at least:
generate embeddings of textual entries in a tabular dataset, wherein the embeddings of the textual entries represent semantic characteristics of the textual entries;
apply a selection algorithm to the embeddings to identify a diverse subset of the textual entries;
send the diverse subset to a language model to obtain labels for the textual entries in the diverse subset;
receive the labels for the textual entries in the diverse subset as output from the language model; and
determine semantic similarity between the embeddings of the textual entries in the diverse subset and the embeddings of the textual entries in a remaining set of the textual entries; and
assign labels for the textual entries in the remaining set based on the labels for the textual entries in the diverse subset and the semantic similarity between the embeddings of the textual entries in the diverse subset and the embeddings of the textual entries in the remaining set.

10. The one or more computer readable storage media of claim 9, wherein the tabular dataset comprises data in a table of a spreadsheet and the program instructions further direct the computing apparatus to populate a column in the spreadsheet with the labels for the textual entries in the diverse subset and the labels for the textual entries in the remaining set.

11. The one or more computer readable storage media of claim 9, wherein to determine the semantic similarity between the embeddings of the textual entries in the diverse subset and the embeddings of the textual entries in a remaining set, the program instructions direct the computing apparatus to apply at least one similarity-based mapping technique to the embeddings of the textual entries in the remaining set, wherein the similarity-based mapping technique propagates the labels for the textual entries in the diverse subset to the textual entries in the remaining set.

12. The one or more computer readable storage media of claim 11, wherein the similarity-based mapping technique comprises at least one of a cosine similarity mapping, a nearest neighbor classification, an embedding distance-based label propagation, a clustering-based label assignment, a classification algorithm-based propagation, and a neural network-based label assignment.

13. The one or more computer readable storage media of claim 9, wherein the selection algorithm comprises at least one of a clustering-based sampling algorithm, a principal component analysis algorithm, a distance-based sampling algorithm, and a stratified random sampling algorithm.

14. The one or more computer readable storage media of claim 9, wherein the language model comprises at least one of a large language model, a transformer-based neural network, and a rule-based text classification system.

15. The one or more computer readable storage media of claim 9, wherein the diverse subset comprises a subset of the textual entries that represent a range of semantic characteristics within the tabular dataset, and wherein the diverse subset is identified based on at least one of distributional coverage, statistical variation, and embedding space density.

16. The one or more computer readable storage media of claim 9, wherein the program instructions further direct the computing apparatus to, prior to assigning the labels for the textual entries in the remaining set, modify the labels for the textual entries in the diverse subset based on user input.

17. A method comprising:
by one or more computing devices:
generating embeddings of textual entries in a tabular dataset, wherein the embeddings of the textual entries represent semantic characteristics of the textual entries;
applying a selection algorithm to the embeddings to identify a diverse subset of the textual entries;
sending the diverse subset to a language model to obtain labels for the textual entries in the diverse subset;
receiving the labels for the textual entries in the diverse subset as output from the language model; and
determining semantic similarity between the embeddings of the textual entries in the diverse subset and the embeddings of the textual entries in a remaining set of the textual entries; and
assigning labels for the textual entries in the remaining set based on the labels for the textual entries in the diverse subset and the semantic similarity between the embeddings of the textual entries in the diverse subset and the embeddings of the textual entries in the remaining set.

18. The method of claim 17, wherein the tabular dataset comprises data in a table of a spreadsheet and the method further comprises populating a column in the spreadsheet with the labels for the textual entries in the diverse subset and the labels for the textual entries in the remaining set.

19. The method of claim 17, wherein determining the semantic similarity between the embeddings of the textual entries in the diverse subset and the embeddings of the textual entries in a remaining set comprises applying at least one similarity-based mapping technique to the embeddings of the textual entries in the remaining set, wherein the similarity-based mapping technique propagates the labels for the textual entries in the diverse subset to the textual entries in the remaining set.

20. The method of claim 19, wherein the similarity-based mapping technique comprises at least one of a cosine similarity mapping, a nearest neighbor classification, an embedding distance-based label propagation, a clustering-based label assignment, a classification algorithm-based propagation, and a neural network-based label assignment.
